(19) United States
(12) Patent Application Publication
(10) Pub. No.: US 2007/0082296 A1
(43) Pub. Date: Apr. 12, 2007

(54) Method of forming micro-patterns using multiple photolithography process

(75) Inventors: Song-yi Yang, Seoul (KR); Kyeong-koo Chi, Seoul (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/545,417

(22) Filed: Oct. 10, 2006

(30) Foreign Application Priority Data
Oct. 11, 2005 (KR) 10-2005-0095503

(51) Int. Cl. G03C 5/00

(52) U.S. Cl. 430/311; 430/322; 430/312; 430/313

(57) ABSTRACT

Provided is a method of forming micro-patterns using a multi-photolithography process, including: providing an etch target layer where micro-patterns are to be formed; forming a mask layer on the etch target layer; forming a first mask pattern including engraved portions and embossed portions by etching a predetermined region of the mask layer; forming a final mask pattern in the first mask pattern by etching a predetermined region of the residual embossed portions of the mask layer; and forming micro-patterns by etching the etch target layer using the final mask pattern as an etch mask.

### CROSS-REFERENCE TO RELATED PATENT APPLICATION

This application claims priority to Korean Patent Application No. 10-2005-0095503, filed on Oct. 11, 2005, in the Korean Intellectual Property Office, the disclosure of which is incorporated herein in its entirety by reference.

### BACKGROUND OF THE INVENTION

1. Field of the Invention

The present invention relates to a method of forming micro-patterns, and more particularly, to a method of forming micro-patterns using a multiple photolithography process.

2. Description of the Related Art

A patterning process used for manufacturing a semiconductor device is a process of patterning a predetermined material layer formed on a wafer, and generally includes applying a photosensitive film, exposing the film, and developing the film, in that order. Relatively small patterns can be referred to as micro-patterns.

When forming micro-patterns the most significant factor during the patterning process is resolution, which depends on a light source and a lens apparatus used in a photolithography process.

The increased integration required for semiconductor devices having micro-patterns and the reduction in design rules used to achieve the integration result in a need for an increase in the resolution of the photolithography process. Accordingly, the realization of a high resolution, beyond the limited resolution of a light source and a lens apparatus employed in a conventional optical lithography process, is required. Thus research focusing on a numerical aperture (NA) and a resolution enhancement technique (RET) has been performed.

Due to such endeavors, a resolution of 60 nm has been attained for manufacturing devices using a dry ArF lithography process. However, there are several drawbacks in the photolithography process. That is, as defects between micro-patterns increase, such as, shorts, bridges, and pattern collapse, the yield of the devices decreases. Further, as the thicknesses of photoresists (Tpr) used for patterning continuously decrease, the photoresist cannot perform as a mask for subsequent etching processes. In addition, when the high numerical aperture is employed, there are problems in that the angle of incidence of light increases and the reflection ratio also increases.

In addition, as semiconductor devices become more highly integrated, light transmitted through a photo mask having adjacent micro-patterns is diffracted and interferes when an exposure process is performed, such that a uniform critical dimension (CD) for the patterns cannot be obtained.

To overcome the problems resulting from the small thicknesses of photoresists (Tpr) and the increase in the reflection ratio, structures having a multi-mask and an anti-reflection layer between a photoresist layer and an etch target layer have been suggested.

The anti-reflection layer is used in a semiconductor lithography process as a very thin light-absorbing photosensitive material layer to stabilize essential micro-circuits for manufacturing gigabit (Gb) level ultra highly integrated semiconductors and should be matched with high resolution photoresist materials used in conventional processes to obtain good mutual interface contacting characteristics and light characteristics. Such anti-reflection layers are classified into top anti-reflective coating (TARC) layers when coated on the top surface of a photoresist layer and bottom anti-reflective coating (BARC) layers when coated on the bottom surface of a photoresist layer. BARC layers are used more in highly integrated semiconductor processes.

In addition, to minimize light interference due to light diffraction in micro-patterns during an exposing process, a multi-lithography method using a plurality of photo masks is employed to form micro-patterns.

FIGS. 1 through 12 are cross-sectional views illustrating a conventional method of forming micro-patterns in a semiconductor device. Referring to FIG. 1, a multi-layered mask layer 80, a first anti-reflection layer 50, and a first photoresist layer 60 are formed on an etch target layer 10. The multi-layered mask layer 80 is formed on the etch target layer 10, and includes a nitride layer 20, an amorphous carbon layer 30, and a silicon oxynitride layer 40. The thin first anti-reflection layer 50 and the first photoresist layer 60 are formed on the multi-layered mask layer 80. Accordingly, a five layer structure is formed on the etch target layer 10.

Referring to FIG. 2, a first photoresist pattern 61 is formed by exposing and developing the first photoresist layer 60 using a first photo mask 70. Here, a first light blocking pattern 70a made of chrome, etc., is formed on a bottom surface of the first photo mask 70.

Referring to FIG. 3, a first anti-reflection pattern 51 is formed by etching the first anti-reflection layer 50 using the first photoresist pattern 61 as an etch mask.

Referring to FIG. 4, a first silicon oxynitride pattern 41 is formed by partially etching the silicon oxynitride layer 40 using the first photoresist pattern 61 and the first anti-reflection pattern 51 as an etch mask.

Referring to FIG. 5, the first photoresist pattern 61 and the first anti-reflection pattern 51 disposed on the first silicon oxynitride pattern 41 are removed.

Referring to FIG. 6, a second photoresist layer 62 is formed on the first silicon oxynitride pattern 41.

Referring to FIG. 7, a second photoresist pattern 63 is formed by exposing and developing the second photoresist layer 62 using a second photo mask 71 having a second light blocking pattern 71a. The second photoresist pattern 63 is formed in the engraved portions of the first silicon oxynitride pattern 41.

Referring to FIG. 8, a final silicon oxynitride pattern 42 is formed by etching first silicon oxynitride pattern 41 using the second photoresist pattern 63 as an etch mask.

Referring to FIG. 9, the second photoresist pattern 63 is removed and an amorphous carbon pattern 31 is formed by etching the amorphous carbon layer 30 using the final silicon oxynitride pattern 42 as an etch mask.

Referring to FIG. 10, the final silicon oxynitride pattern 42 is removed and a nitride pattern 21 is formed by etching the nitride layer 20 using the amorphous carbon pattern 31 as an etch mask.

Referring to FIG. 11, the amorphous carbon pattern 31 is removed and an etch target pattern 11 is formed by etching the etch target layer 10 using the nitride pattern 21 as an etch mask.

Referring to FIG. 12, the nitride pattern 21 is removed.

As described above, in the conventional process of forming micro-patterns in a highly integrated semiconductor device, a lower anti-reflection layer should be formed before forming the photoresist pattern in order to block light reflected when an exposure process is performed. However, in the conventional process of forming the second photoresist pattern 62, it is difficult to uniformly form a lower anti-reflection layer because of the influence of the first silicon oxynitride pattern 41 previously formed.

As illustrated in FIG. 7, since a positive patterning technique is used for forming the first silicon oxynitride pattern 41 in which the widths of embossed portions are less than those of engraved portions. If a spin-coating process is performed to form an anti-reflection layer (not shown) on the first silicon oxynitride pattern 41, the anti-reflection layer might not be formed flatly. Rather, the anti-reflection layer could be formed concavely on engraved portions disposed between embossed portions in the first silicon oxynitride pattern 41. When a photoresist pattern is formed using a photolithography process after forming a photoresist layer on the anti-reflection layer, which is not flat, the photoresist pattern may collapse, bridges may be generated in the photoresist pattern, and/or the sidewall profile of the photoresist pattern may be unfavorable. Consequently, if the subsequent processes are performed using this photoresist pattern as an etch mask, a desired micro-pattern cannot be obtained. Therefore, providing a second anti-reflection layer on the first silicon oxynitride layer 41 pattern, given the positive patterning technique of the first silicon oxynitride layer 41 pattern, could lead to defects in the micro-patterns of the semiconductor device.

### SUMMARY OF THE INVENTION

The present disclosure provides a method of forming micro-patterns using a multi-photolithography process which is unaffected by previously formed patterns.

The present disclosure also provides a method of forming micro-patterns in which a flat anti-reflection layer can be formed without influence from patterns previously formed, and thus allowing the flat anti-reflection layer to be used favorably as a photoresist pattern.

According to an aspect of the present disclosure, there is provided a method of forming micro-patterns including: providing an etch target layer where micro-patterns are to be formed; forming a mask layer on the etch target layer; forming a first mask pattern including engraved portions and embossed portions by etching at least one region of the mask layer; forming a final mask pattern by etching at least one region of the embossed portions of the mask layer; and forming micro-patterns by etching the etch target layer using the final mask pattern as an etch mask.

The first mask pattern can be a line and space pattern in which embossed portions and engraved portions are alternately formed, and the widths of the embossed portions can be greater than the widths of the engraved portions.

The mask layer can be a multi-layered mask layer.

The multi-layered mask layer can include a silicon nitride layer, an amorphous carbon layer, and a silicon oxynitride layer stacked sequentially.

The multi-layered mask layer can include a silicon nitride layer, an amorphous carbon layer, an oxide layer, and a silicon oxynitride layer stacked sequentially.

The forming of the first mask pattern can include: forming a first photoresist pattern on the multi-layered mask layer; and forming the engraved portions of the first mask pattern by etching at least a portion of the multi-layered mask layer using the first photoresist pattern as an etch mask. The multi-layered mask can include an uppermost portion, and forming the engraved portions in the first mask pattern can include etching at least a portion of the uppermost layer of the multi-layered mask layer.

The method can further include, after the forming of the first mask pattern: forming an anti-reflection layer on the first mask pattern using, for example, spin-coating; and forming a second photoresist pattern which exposes portions of the anti-reflection layer on the embossed portions of the mask layer.

According to another aspect of the present invention, there is provided a method of forming micro-patterns including: providing an etch target layer where micro-patterns are to be formed; forming a hard mask layer on the etch target layer; forming a intermediate layer on the hard mask layer; forming a first intermediate pattern including engraved portions and embossed portions by etching at least one region of the intermediate layer; forming a final intermediate pattern in the first intermediate pattern by etching at least one region of the embossed portions of the intermediate layer; forming hard mask pattern by etching the hard mask layer using the final intermediate pattern as an etch mask; and forming micro-patterns by etching the etch target layer using the hard mask pattern as an etch mask.

The hard mask layer can be a silicon nitride layer. The intermediate layer can be a mono-layered or multi-layered intermediate layer, for example, an amorphous carbon layer and a silicon oxynitride layer stacked sequentially. In the multi-layered intermediate layer, the silicon oxynitride layer can be partially etched to a predetermined depth to expose the oxide layer during the forming of the first intermediate pattern.

The forming of the first intermediate pattern can include: forming a first photoresist pattern on the multi-layered intermediate layer; and forming the engraved portions of the first intermediate pattern by etching at least a portion of the multi-layered intermediate layer using the first photoresist pattern as an etch mask. The multi-layered intermediate layer can include an uppermost layer, and forming the engraved portions in the first intermediate pattern can include etching the uppermost layer of the multi-layered intermediate layer.

The method can further include, after the forming of the first mask pattern: forming an anti-reflection layer on the first intermediate pattern; and forming a second photoresist pattern which exposes portions of the anti-reflection layer on the embossed portions of the hard mask layer.

According to still another aspect of the present invention, there is provided a method of forming micro-patterns including: preparing an etch target layer where micro-patterns are to be formed; forming a hard mask layer on the etch target layer; sequentially forming a first intermediate layer and a second intermediate layer on the hard mask layer; forming a first photoresist pattern on the second intermediate layer; forming a second intermediate pattern being a line and space pattern with the widths of embossed portions being greater than the widths of engraved portions by etching a predetermined region of the second intermediate layer; forming an anti-reflection layer on the entire surface of the second intermediate pattern; forming a second photoresist pattern which exposes portions of the embossed portions of the second intermediate layer, on the anti-reflection layer; forming a final second intermediate pattern in the second intermediate pattern by etching the embossed portions of the second intermediate layer using the second photoresist pattern as an etch mask; forming a first intermediate pattern by etching the first intermediate layer using the final second intermediate pattern as an etch mask; forming a hard mask pattern by etching the hard mask layer using the first intermediate pattern as an etch mask; and forming micro-patterns by etching the etch target layer using the hard mask pattern as an etch mask.

The method can further include forming an anti-etching intermediate layer between the first intermediate layer and the second intermediate layer. In the forming of the second intermediate pattern, the second intermediate layer can be partially etched to a predetermined depth or etched completely to expose the anti-etching intermediate layer.

According to various aspects of the present invention, a multi-layered mask layer can be employed as a mask layer for an etch target layer to be patterned and a multi-exposure process using an ArF eximer laser having a wavelength of 193 nm as a light source can also be employed. Thus, micro-patterns with a critical dimension of less than 60 nm can be formed in a semiconductor device.

### BRIEF DESCRIPTION OF THE DRAWINGS

Various aspects of this disclosure will become more apparent in view of the attached drawing figures, which are provided by way of example, not by way of limitation.

FIGS. 1 through 12 are cross-sectional views illustrating a conventional prior art method of forming micro-patterns;

FIGS. 13 through 27 are cross-sectional views illustrating a method of forming micro-patterns according to an embodiment of the present disclosure; and

FIGS. 28 through 42 are cross-sectional views illustrating a method of forming micro-patterns according to another embodiment of the present disclosure.

### DETAILED DESCRIPTION OF THE INVENTION

Hereinafter, embodiments in accordance with various aspects of the present disclosure will be described more fully with reference to the accompanying drawings, in which exemplary embodiments are shown. It will also be understood that when a layer is referred to as being “on” another layer or a substrate, it can be directly on the other layer or the substrate, or intervening layers can also be present. In any given layer or a substrate, there can be at least two surface levels formed in portions thereof, i.e., a higher level and a lower level. The higher level can be referred to as an “embossed” portion of the layer or substrate and the lower level can be referred to as an “engraved” portion of the layer or substrate. As an example, the engraved portion can be formed by etching and the embossed portions can be unetched. As used herein a “pattern” is a layer having at least one engraved portion, and can also be referred to as a “layer pattern.” In the drawings, like reference numerals denote like elements, and the sizes and thicknesses of layers and regions are exaggerated for clarity. Thickness in the embodiments below are intended to be representative, and not limiting.

FIGS. 13 through 27 are cross-sectional views illustrating an exemplary embodiment of a method of forming micro-patterns in a target layer of a semiconductor device according to an embodiment of the present disclosure.

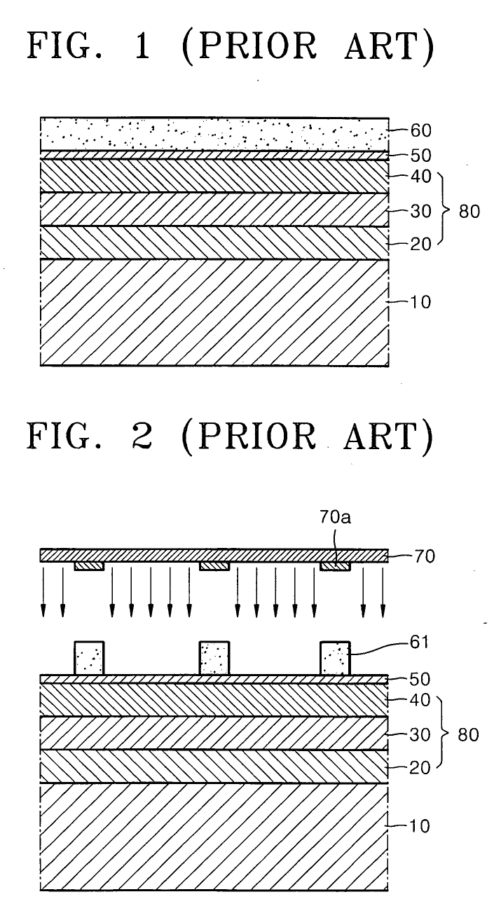

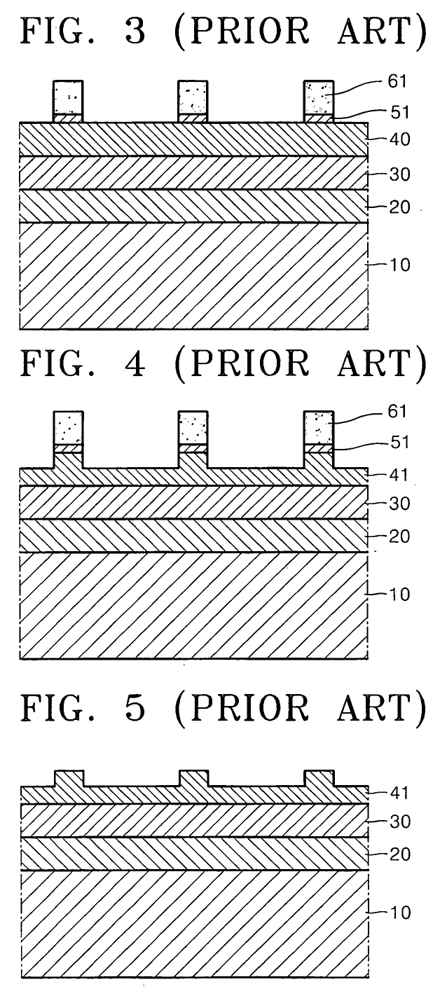

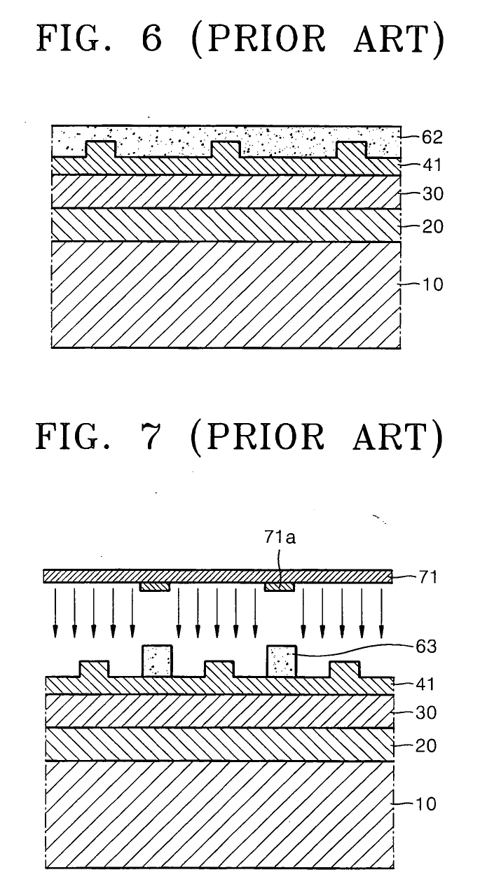

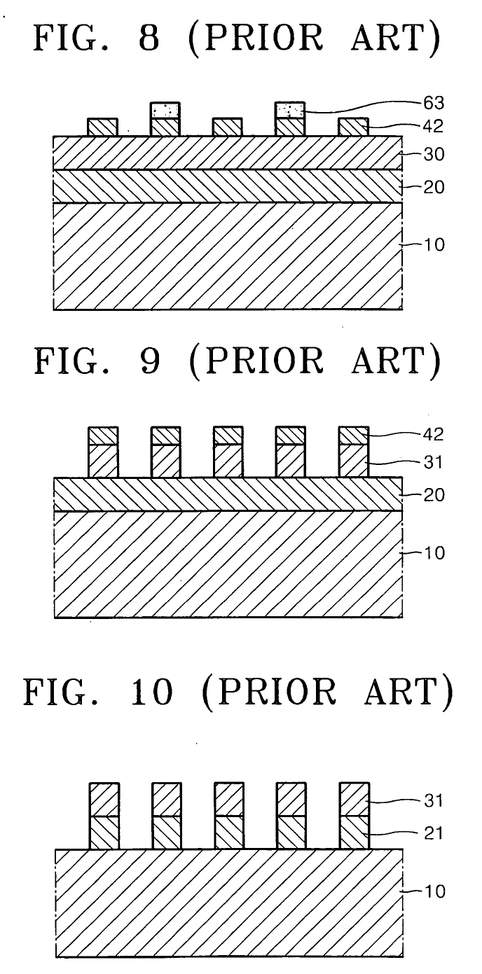

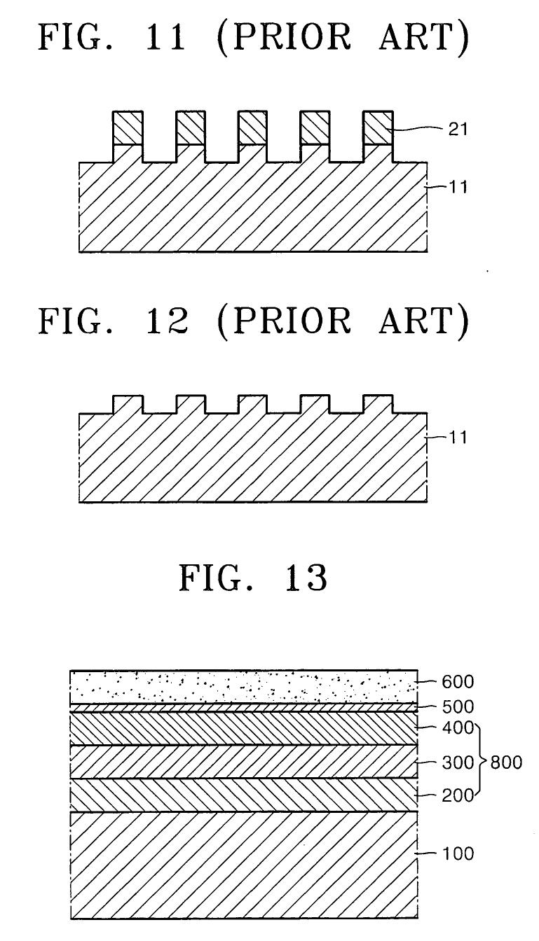

Referring to FIG. 13, a multi-layered mask layer 800, a first anti-reflection layer 500, and a first photoresist layer 600 are formed on an etch target layer 100. The multi-layered mask layer 800 is formed on the etch target layer 100, which can be, for example, a semiconductor material layer, an insulation layer, a conduction layer, etc. The multi-layered mask layer 800 includes a silicon nitride layer 200, as a hard mask layer with a thickness of approximately 2000 Å. On the silicon nitride layer 200, the multi-layered mask layer 800 includes an amorphous carbon layer 300, as the first intermediate layer, with a thickness of approximately 1500 Å and a silicon oxynitride layer 400, as a second intermediate layer, with a thickness of approximately 1100 Å. The thin first anti-reflection layer 500 and the first photoresist layer 600 have thicknesses of approximately 380 Å and 1600 Å to 1800 Å, respectively. Accordingly, a five layer structure is formed on the etch target layer 100, which is similar to FIG. 1. Micro-patterns are embodied in an etch target pattern 110 to be formed on the etch target layer 100. The final etch target pattern 110a includes embossed portions and engraved portions arranged with a predetermined distance therebetween, as ultimately shown in FIG. 27.

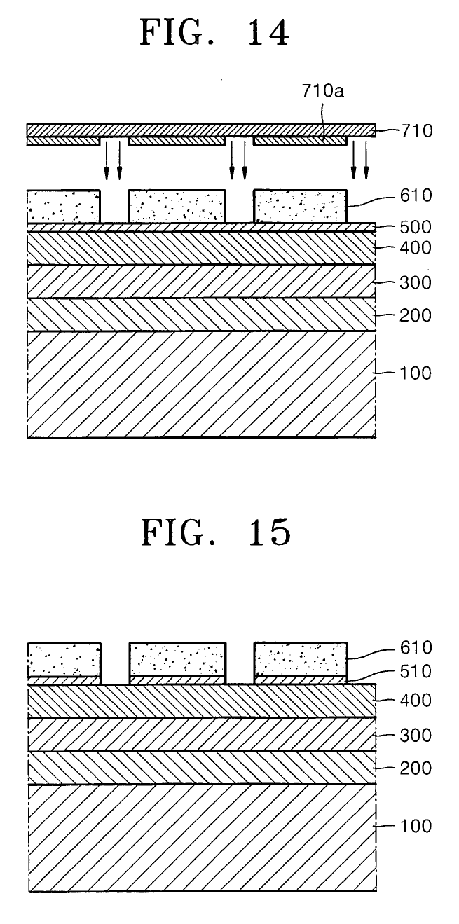

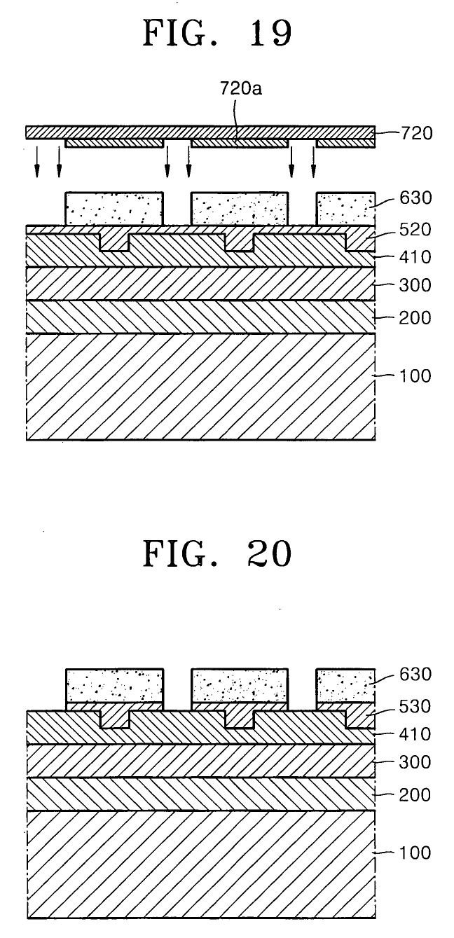

Referring to FIG. 14, a first photoresist pattern 610 is formed in the structure of FIG. 13 by exposing and developing the first photoresist layer 600 using a first photo mask 710. A first light blocking pattern 71Oa is formed on a bottom side of the first photo mask 710 in order to perform a first photolithography process. The first light blocking pattern 710a is formed with a proper spacing and shape corresponding to the etch target pattern 110 (see FIG. 27) to be formed. In the current embodiment, the etch target pattern 110 is a line and space pattern in which embossed portions and engraved portions having respective predetermined widths are alternately formed. In these embodiments, the widths of the engraved portions in the first photoresist pattern 610 are less than those of embossed portions in the first photoresist pattern 610. The first photo mask 710 and a second photo mask 720 (see FIG. 19) are separately formed to collectively define the etch target pattern 110 by a multi-photolithography process. These photo masks are shaped to correspond to the engraved portions of the etch target pattern 110. That is, for example, the first photo mask 710 includes regularly divided portions for exposing substantially parallel, odd engraved portions in the etch target pattern 110, and a second photo mask 720 used in a subsequent process includes regularly divided portions for exposing substantially parallel, even engraved portions in the etch target pattern 110. Here, the odd portions and the even portions are arbitrarily chosen from either side in the etch target 110.

Referring to FIG. 15, a first anti-reflection pattern 510 is formed by etching the first anti-reflection layer 500 using the first photoresist pattern 610 as an etch mask. The etching process can be anisotropic dry etching, for example, dry etching using plasma, reactive ion etching, and so on. Such dry etching processes are known in the art, so not described in detail herein.

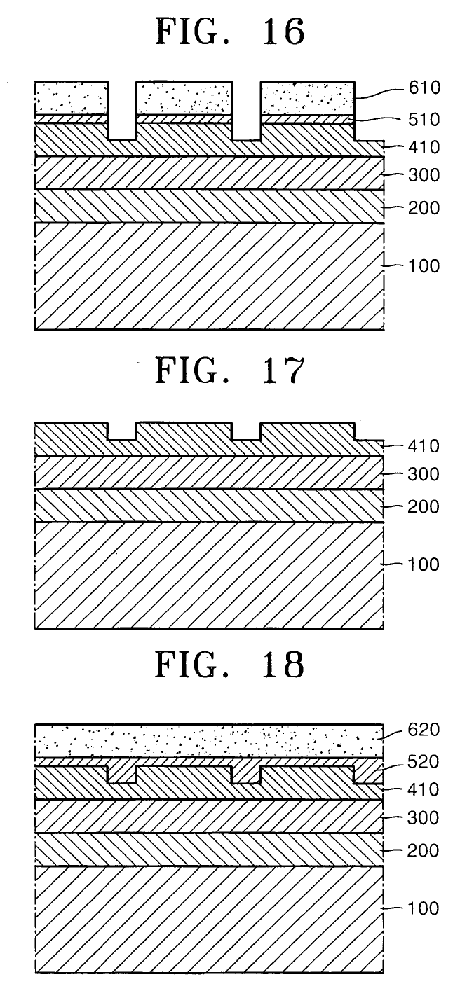

Referring to FIG. 16, a first silicon oxynitride pattern 410 is formed by partially etching the silicon oxynitride layer 400 using the first photoresist pattern 610 and the first anti-reflection pattern 510 as an etch mask. When the layer under the silicon oxynitride layer 400 is the amorphous carbon layer 300, the first silicon oxynitride pattern 410 is partially etched to a predetermined depth so as not to expose the amorphous carbon layer 300. Since the amorphous carbon layer 300 has similar etch selectivity to the photoresist pattern 610 and the first anti-reflection pattern 510, the amorphous carbon layer 300 could be damaged if exposed when removing the photoresist pattern 610 and the first anti-reflection pattern 510 after forming the first silicon oxynitride pattern 410.

Referring to FIG. 17, the first photoresist pattern 610 and the first anti-reflection pattern 510 disposed on the first silicon oxynitride pattern 410 are removed, for example, using a conventional ashing and stripping process. In doing so, the first silicon oxynitride pattern 410 is exposed.

Referring to FIG. 18, a second anti-reflection layer 520 and a second photoresist layer 620 are sequentially formed on the first silicon oxynitride pattern 410. The second anti-reflection layer 520 can be formed on the first silicon oxynitride pattern 410 using a spin-coating method, for example. Since the embossed portions of the first silicon oxynitride pattern 410 are wider than the engraved portions, the second anti-reflection layer 520 can be formed uniformly and flatly on the embossed portions. Thus, a second photoresist pattern 630 (see FIG. 20) can be favorably formed on the flat second anti-reflection layer 520, as described later with respect to FIG. 20.

Referring to FIG. 19, a second photoresist pattern 630 is formed by exposing and developing the second photoresist layer 620 using the second photo mask 720, which has a second light blocking pattern 720a. The second photoresist pattern 630 is formed by the second photo mask 720 having a second light blocking pattern 720a corresponding to engraved portions to be formed in the embossed portions not exposed by the first photoresist pattern 610.

Referring to FIG. 20, a second anti-reflection pattern 530 is formed by etching the second anti-reflection layer 520 using the second photoresist pattern 630 as an etch mask. The etching can be an anisotropic dry etching, for example, dry etching using plasma, reactive ion etching, and so on. Such dry etching processes are known in the art, as mentioned above.

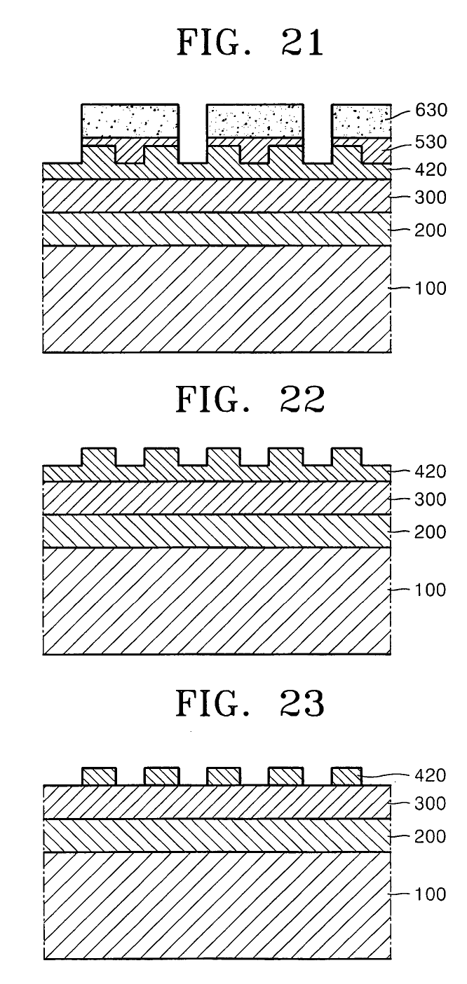

Referring to FIG. 21, a second, here a final, silicon oxynitride pattern 420 is formed in the silicon oxynitride layer 400 by etching the first silicon oxynitride pattern 410 (see FIG. 17) using the second photoresist pattern 630 and the second anti-reflection pattern 530 as an etch mask. The embossed portions of the first silicon oxynitride pattern 410 are exposed by the second photoresist pattern 630 and etched to define other engraved portions of the silicon oxynitride layer 400, in addition to the engraved portions formed by the first photoresist pattern 610. As a result, the final silicon oxynitride pattern 420 has the same image as the etch target pattern 110 to be formed in FIG. 27.

Referring to FIG. 22, the second photoresist pattern 630 and the second anti-reflection pattern 530 disposed on the final silicon oxynitride pattern 420 are removed, for example, using a conventional ashing and stripping process. In doing so, the final silicon oxynitride pattern 420 is exposed.

Referring to FIG. 23, the final silicon oxynitride pattern 420 is etched to expose the amorphous carbon layer 300 thereunder.

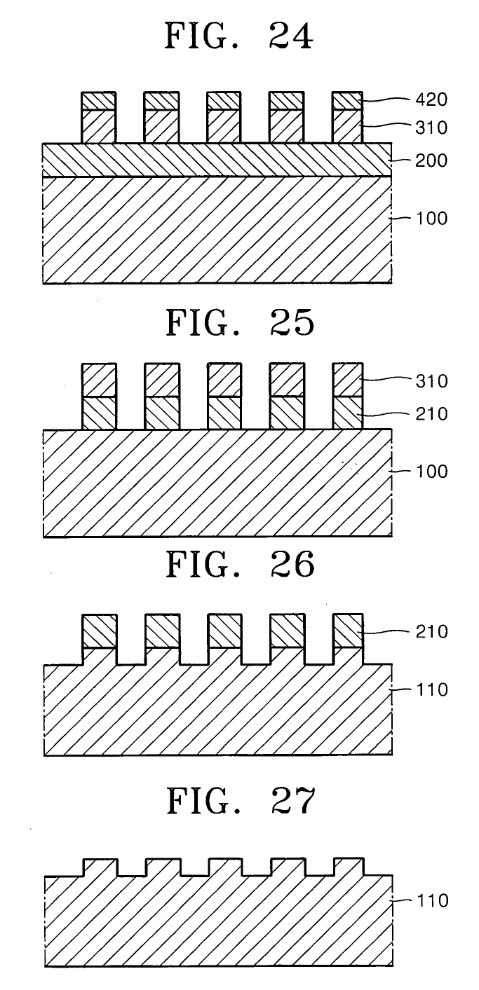

Referring to FIG. 24, an amorphous carbon pattern 310 is formed by etching the amorphous carbon layer 300 using the final silicon oxynitride pattern 420 as an etch mask. The final silicon oxynitride pattern 420 used as a hard mask for forming the amorphous carbon pattern 310 can partially remain on the amorphous carbon pattern 310 when the forming of the amorphous carbon pattern 310 is finished.

Referring to FIG. 25, a nitride pattern 210 is formed by etching the nitride layer 200 using the amorphous carbon pattern 310 as an etch mask. At this time, the final silicon oxynitride pattern 420 can be used with the amorphous carbon pattern 310 to etch the nitride layer 200, or can be removed before forming the nitride pattern 210. The amorphous carbon pattern 310 used as a hard mask for forming the nitride pattern 210 can partially remain on the nitride pattern 210 when the forming of the nitride pattern 210 is finished.

Referring to FIG. 26, the etch target pattern 110 is formed by etching the etch target layer 100 using the nitride pattern 210 as an etch mask. At this time, the amorphous carbon pattern 310 can be used with the nitride pattern 210 to etch the etch target layer 100, or can be removed before forming the etch target pattern 110. The nitride pattern 210 used as a hard mask for forming the etch target pattern 110 can partially remain on the etch target pattern 110 when the forming of the etch target pattern 110 is finished.

Referring to FIG. 27, the nitride pattern 210 disposed on the etch target pattern 110 is removed.

In the method of forming micro-patterns according to the current embodiment, the silicon oxynitride layer 400 is disposed on the amorphous carbon layer 300, and the first silicon oxynitride pattern 410 is partially etched so as not to expose the amorphous carbon layer 300. It is desirable to also form the final silicon oxinitride pattern within the embossed portions of the first silicon oxynitride pattern 410, without damaging the amorphous carbon layer 300. Since the amorphous carbon layer 300 has similar etch selectivity to the photoresist pattern 610 and the first anti-reflection pattern 510, the amorphous carbon layer 300 could be damaged if exposed when removing the photoresist pattern 610 and the first anti-reflection pattern 510 after forming the first silicon oxynitride pattern 410.

However, since the first silicon oxynitride pattern 410 is formed such that the engraved portions are wider than then embossed portions, a second anti-reflection layer 520 can be formed prior to forming the second photo resist layer 620. As a result, the amorphous carbon layer 300 is protected when forming the final silicon oxynitride pattern 420, after forming the first silicon oxynitride pattern 410, and the risk of defects occurring is mitigated.

According to another exemplary embodiment of the present invention, a multi-mask layer includes an oxide layer, an amorphous carbon layer, a phenyl triethoxysilanes (PTEOS) layer, and a silicon oxynitride layer. The PTEOS lay can serve as an anti-etching layer, as described below.

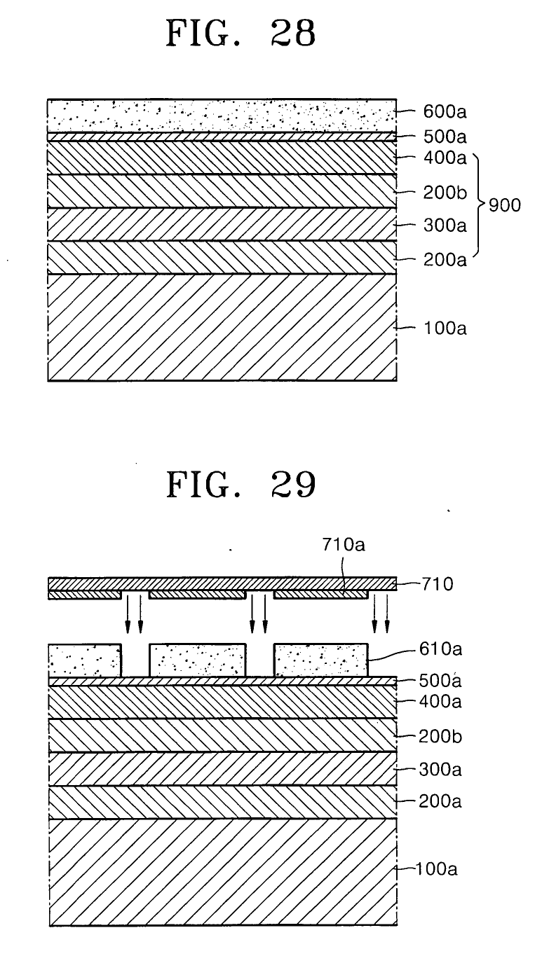

FIGS. 28 through 42 are cross-sectional views illustrating a method of forming micro-patterns according to another embodiment of the present invention. Descriptions of operations identical, or substantially similar, to those in the previous embodiment will be omitted.

Referring to FIG. 28, a multi-layered mask layer 900, a first anti-reflection layer 500a, and a first photoresist layer 600a are formed on an etch target layer 100a. The multi-layered mask layer 900 is formed on the etch target layer 100a, and can include, for example, a nitride layer or oxide layer 200a with a thickness of approximately 2000 Å, an amorphous carbon layer 300a with a thickness of approximately 1800 Å, a PTEOS layer 200b with a thickness of approximately 700 Å, and a silicon oxynitride layer 400a with a thickness of approximately 600 Å. The thin first anti-reflection layer 500a and the first photoresist layer 600a have thicknesses of approximately 380 Å and 1600 Å to 1800 Å, respectively. Accordingly, a six layer structure is formed on the etch target layer 100a. Using the method described below, micro-patterns are ultimately embodied in an etch target pattern 110a formed in the etch target layer 100a. The etch target pattern 110 includes embossed portions and engraved portions arranged with a predetermined distance therebetween, as ultimately shown in FIG. 42.

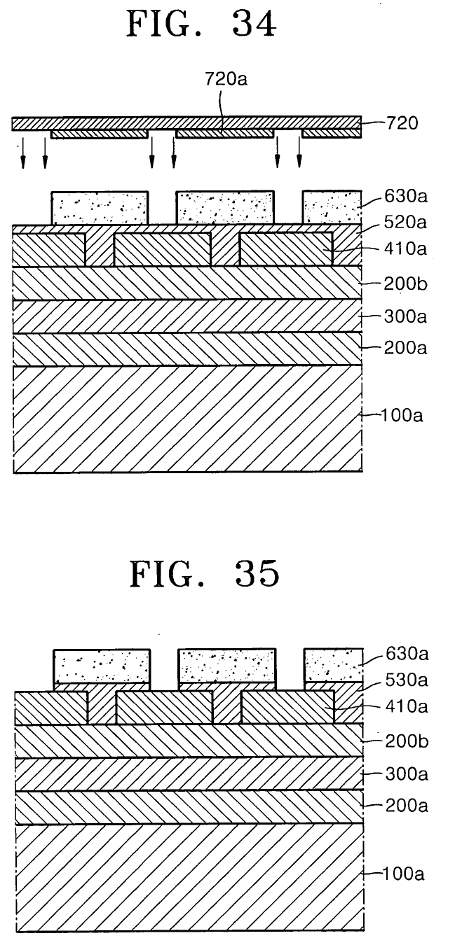

As with the method of FIGS. 13-27, the first photo mask 710 and the second photo mask 720 (see FIG. 34) are separately formed to define the etch target pattern 110a by a multi-photolithography process. The first and the second photo masks 710 and 720 have shapes used to ultimately form the engraved portions of the etch target pattern 110a. That is, for example, the first photo mask 710 includes regularly divided portions for exposing substantially parallel, odd engraved portions in the etch target layer real pattern 110a, and the second photo mask 720 used in a subsequent process includes regularly divided portions for exposing substantially parallel, even engraved portions in the etch target pattern 110a. Here, the odd portions and the even portions are arbitrarily chosen from either side in the etch target layer real pattern 110a.

Referring to FIG. 29, a first photoresist pattern 610a is formed in the structure of FIG. 28 by exposing and developing the first photoresist layer 600a using the first photo mask 710. Photo mask 710 includes the first light blocking pattern 710a, as in FIG. 14, formed on the bottom side of the first photo mask 710 used in the first photolithography process.

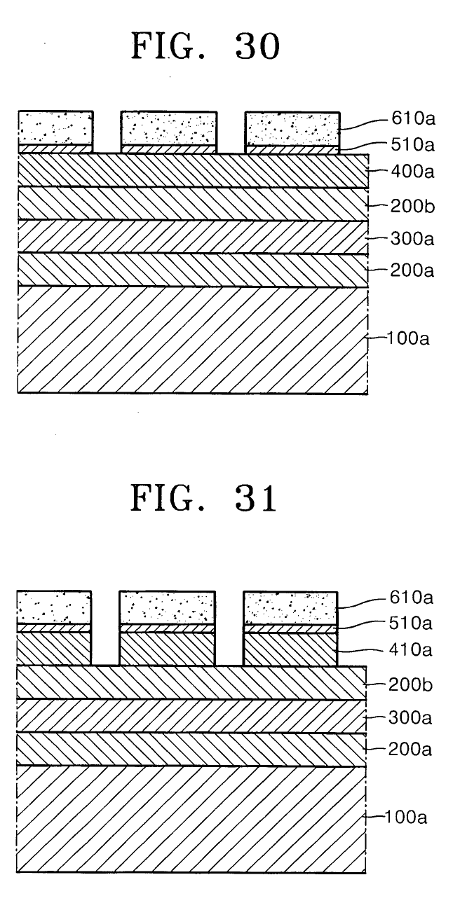

Referring to FIG. 30, a first anti-reflection pattern 510a is formed by etching the first anti-reflection layer 500a using the first photoresist pattern 610a as an etch mask. The etching process can be an anisotropic dry etching, for example, dry etching using plasma, reactive ion etching, etc., as mentioned above.

Referring to FIG. 31, a first silicon oxynitride pattern 410a is formed by partially etching the silicon oxynitride layer 400a using the first photoresist pattern 610a and the first anti-reflection pattern 510a as an etch mask. When the layer under the silicon oxynitride layer 400a is an oxide layer, such as the PTEOS layer 200b, the first silicon oxynitride pattern 410a is over-etched using the PTEOS layer 200b as an etch stopping layer. Since the etch selectivity between the PTEOS layer 200b and each of the first photoresist pattern 610a and the first anti-reflection pattern 510a is very high, the PTEOS layer 200b is not damaged if exposed when the first photoresist pattern 610a and the first anti-reflection pattern 510a are removed after forming the first silicon oxy-nitride pattern 410a.

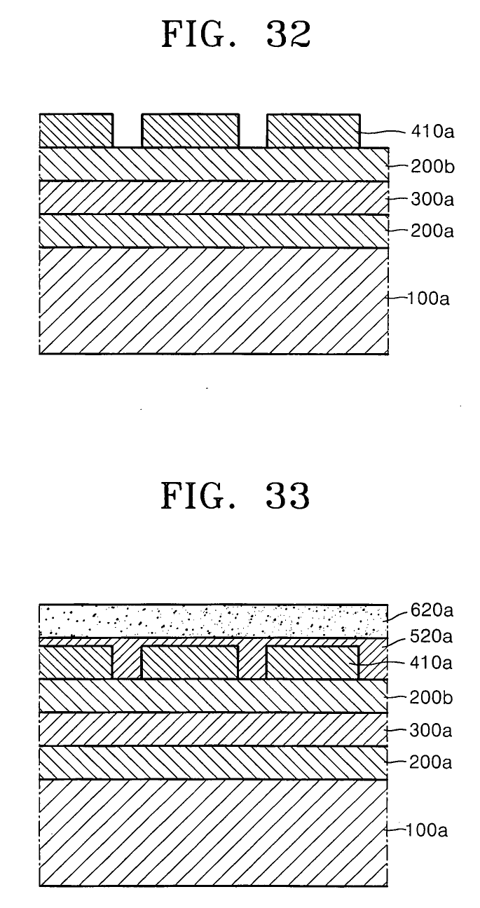

Referring to FIG. 32, the first photoresist pattern 610a and the first anti-reflection pattern 510a disposed on the first silicon oxynitride pattern 410a are removed using a conventional ashing and stripping process, for example.

Referring to FIG. 33, a second anti-reflection layer 520a and a second photoresist layer 620a are formed on the first silicon oxynitride pattern 410a. Since the second anti-reflection layer 520a is substantially flatly formed on the embossed portions of the first silicon oxynitride pattern 410a, the second photoresist layer 620a can be favorably formed (e.g., substantially flatly formed).

Referring to FIG. 34, a second photoresist pattern 630a is formed by exposing and developing the second photoresist layer 620a using the second photo mask 720, as in FIG. 19. The second photoresist pattern 630a is formed to expose engraved portions of the etch target pattern 110a, in addition to the engraved portions formed by the first photoresist pattern 610a.

Referring to FIG. 35, a second anti-reflection pattern 530a is formed by etching the second anti-reflection layer 520a using the second photoresist pattern 630a as an etch mask. The etching can be an anisotropic dry etching, for example, dry etching using plasma, reactive ion etching, etc., as mentioned above.

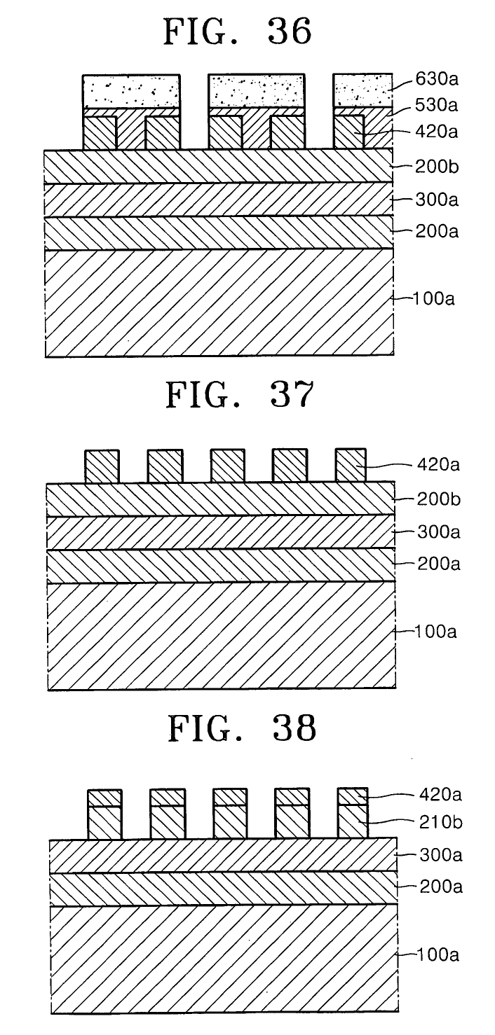

Referring to FIG. 36, a second, and in this embodiment final, silicon oxynitride pattern 420a is formed in the silicon oxynitride layer 400a by etching the first silicon oxynitride pattern 410a (see FIG. 32) using the second photoresist pattern 630a and the second anti-reflection pattern 530a as an etch mask. The embossed portions of the first silicon oxynitride pattern 410a are exposed by the second photoresist pattern 630a and etched to define other engraved portions of the silicon oxynitride layer 400a, in addition to the engraved portions formed by the first photoresist pattern 610a. As a result, the final silicon oxynitride pattern 420a has the same image as the etch target pattern 110a in be formed in FIG. 42.

In addition, the final silicon oxynitride pattern 420a is etched using the PTEOS layer 200b disposed under the final silicon oxynitride pattern 420a as an etch stopping layer. As described with reference to FIG. 31, since the etch selectivity between the PTEOS layer 200b and each of the second photoresist pattern 630a and the second anti-reflection pattern 530a is very high, the PTEOS layer 200b is not damaged if exposed when the second photoresist pattern 630a and the second anti-reflection pattern 530a are removed after forming the final silicon oxynitride pattern 420a.

As described above, since over-etching can be performed when forming the final silicon oxynitride pattern 420a, due to the sufficient etch selectivities between the layers, the pattern shape can be ensured and the occurrence of bridges in the pattern and the consequent decrease in the process margin can be prevented.

Referring to FIG. 37, the second photoresist pattern 630a and the second anti-reflection pattern 530a disposed on the final silicon oxynitride pattern 420a are removed, for example, using a conventional ashing and stripping process. In doing so, the final silicon oxynitride pattern 420a is exposed.

Referring to FIG. 38, a PTEOS pattern 210b is formed by etching the PTEOS layer 200b using the final silicon oxynitride pattern 420a as an etch mask. The final silicon oxynitride pattern 420a, used as a hard mask for forming the PTEOS pattern 210b, can partially remain on the PTEOS pattern 210b when formation of the PTEOS pattern 210b is finished.

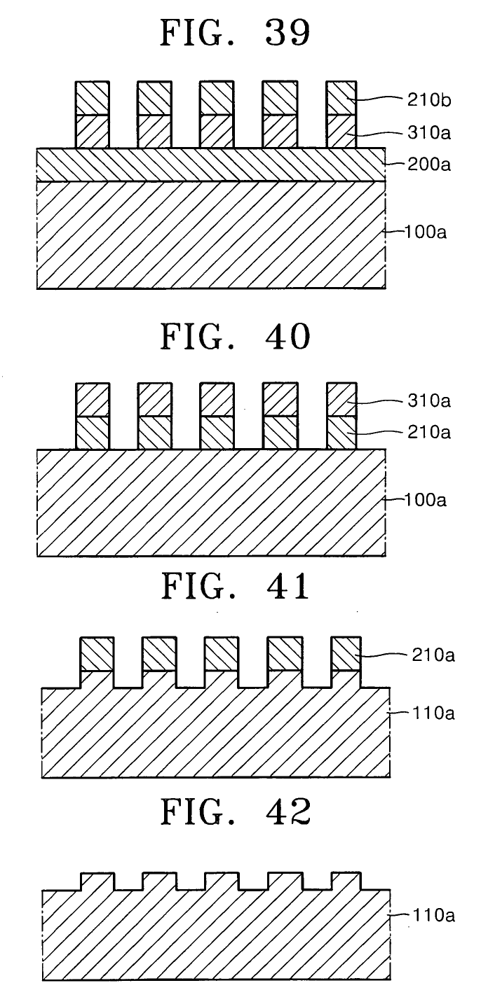

Referring to FIG. 39, an amorphous carbon pattern 310a is formed by etching the amorphous carbon layer 300a using PTEOS pattern 210b as an etch mask. The final silicon oxynitride pattern 420a can be used with the PTEOS pattern 210b to etch the amorphous carbon layer 300a, or can be removed before forming the amorphous carbon pattern 310a. The PTEOS pattern 210b, used as a hard mask for forming the amorphous carbon pattern 310a, can partially remain on the amorphous carbon pattern 310a when formation of the amorphous carbon pattern 310a is finished.

Referring to FIG. 40, an oxide pattern 210a is formed by etching the oxide layer 200a using the amorphous carbon pattern 310a as an etch mask. The PTEOS pattern 210b can be used with the amorphous carbon pattern 310a to etch the oxide layer 200a, or can be removed before forming the oxide pattern 210a. The amorphous carbon pattern 310a, used as a hard mask for forming the oxide pattern 210a, can partially remain on the oxide pattern 210a when formation of the oxide pattern 210a is finished.

Referring to FIG. 41, an etch target pattern 110a can be formed by etching the etch target layer 100a using the oxide pattern 210a as an etch mask. At this time, the amorphous carbon pattern 310a can be used with the oxide pattern 210a to etch the etch target layer 100a, or can be removed before forming the etch target pattern 110a. The oxide pattern 210a, used as a hard mask for forming the etch target pattern 110a, can partially remain on the etch target pattern 110a when formation of the etch target pattern 110a is finished.

Referring to FIG. 42, the oxide pattern 210a disposed on the etch target pattern 110a is removed.

According to the present disclosure, an anti-reflection layer can be formed flatly on a silicon oxynitride pattern having engraved portions and embossed portions, and a photoresist pattern can subsequently be substantially flatly formed on the silicon oxyntride pattern. As a result, the risk of defects in micro-patterns ultimately formed in the target layer are mitigated.

In the embodiments above, photoresist patterns can be formed using any known or hereafter developed light sources. As an example, an ArF eximer laser having a wavelength of 193 nm can be used as an exposure light source to form the first photoresist pattern and the second photoresist pattern discussed above. Thus, micro-patterns with a critical dimension of less than 60 nm can be formed in a semiconductor device, as an example. Dimensions greater than 60 nm can also be attained, if desirable.

While aspects of the present invention have been particularly shown and described with reference to the above exemplary embodiments, it will be understood by those of ordinary skill in the art that various changes in form and details can be made therein without departing from the spirit and scope of the present disclosure and invention. It is intended, therefore, by the following claims to claim that which is literally described and all equivalents thereto, including all modifications and variations that fall within the scope of each claim.

What is claimed is:

1. A method of forming micro-patterns in a semiconductor device, the method comprising:
providing an etch target layer where micro-patterns are to be formed;
forming a mask layer on the etch target layer;
forming a first mask pattern including engraved portions and embossed portions by etching at least one region of the mask layer;
forming a final mask pattern by etching at least one region of the embossed portions of the first mask pattern; and
forming micro-patterns by etching the etch target layer using the final mask pattern as an etch mask.

2. The method of claim 1, wherein the first mask pattern is a line and space pattern in which embossed portions and engraved portions are alternately formed, and the widths of the embossed portions are greater than the widths of the engraved portions.

3. The method of claim 1, wherein the mask layer is a multi-layered mask layer.

4. The method of claim 3, wherein the forming of the first mask pattern comprises:
forming a first photoresist pattern on the multi-layered mask layer; and
forming the engraved portions of the first mask pattern by etching at least a portion of the multi-layered mask layer using the first photoresist pattern as an etch mask.

5. The method of claim 4, wherein the multi-layered mask layer includes an uppermost layer, and forming the engraved portions in the first mask pattern includes etching at least a portion of the uppermost layer partially or completely.

6. The method of claim 4, further comprising, after the forming of the first mask pattern:
forming an anti-reflection layer on the first mask pattern; and
forming a second photoresist pattern which exposes portions of the anti-reflection layer on the embossed portions of the mask layer.

7. The method of claim 6, wherein the anti-reflection layer is formed using a spin-coating method.

8. The method of claim 3, wherein the multi-layered mask layer comprises a silicon nitride layer, an amorphous carbon layer, and a silicon oxynitride layer stacked sequentially.

9. The method of claim 3, wherein the multi-layered mask layer comprises a silicon nitride layer, an amorphous carbon layer, an oxide layer, and a silicon oxynitride layer stacked sequentially.

10. A method of forming micro-patterns comprising:
providing an etch target layer where micro-patterns are to be formed;
forming a hard mask layer on the etch target layer;
forming an intermediate layer on the hard mask layer;
forming a first intermediate pattern including engraved portions and embossed portions by etching at least one region of the intermediate layer;
forming a final intermediate pattern in the first intermediate pattern by etching at least one region of the embossed portions of the intermediate layer;
forming hard mask pattern by etching the hard mask layer using the final intermediate pattern as an etch mask; and
forming micro-patterns by etching the etch target layer using the hard mask pattern as an etch mask.

11. The method of claim 10, wherein the first intermediate pattern is a line and space pattern in which embossed portions and engraved portions are alternately formed, and the widths of the embossed portions are greater than the widths of the engraved portions.

12. The method of claim 10, wherein the intermediate layer is a multi-layered intermediate layer.

13. The method of claim 12, wherein the forming of the first intermediate pattern comprises:
forming a first photoresist pattern on the multi-layered intermediate layer; and
forming the engraved portions of the first intermediate pattern by etching at least a portion of the multi-layered intermediate layer using the first photoresist pattern as an etch mask.

14. The method of claim 13, wherein the multi-layered intermediate layer includes an uppermost layer, and forming the engraved portions in the first intermediate pattern includes etching the on at least a portion of the uppermost layer partially or completely.

15. The method of claim 13, further comprising, after the forming of the first mask pattern:
forming an anti-reflection layer on the first intermediate pattern; and
forming a second photoresist pattern which exposes portions of the anti-reflection layer on the embossed portions of the hard mask layer.

16. The method of claim 15, wherein the anti-reflection layer is formed using a spin-coating method.

17. The method of claims 15, wherein an ArF eximer laser having a wavelength of 193 nm is used as an exposure light source to form at least one of the first photoresist pattern and the second photoresist pattern.

18. The method of claim 12, wherein the multi-layered intermediate layer comprises an amorphous carbon layer and a silicon oxynitride layer stacked sequentially, and the silicon oxynitride layer is partially etched to a predetermined depth during the forming of the first intermediate pattern.

19. The method of claim 12, wherein the multi-layered intermediate layer comprises an amorphous carbon layer, an oxide layer, and a silicon oxynitride layer stacked sequentially, and the silicon oxynitride layer is etched completely to expose the oxide layer during the forming of the first intermediate pattern.

20. The method of claim 10, wherein the hard mask layer is a silicon nitride layer.

21. A method of forming micro-patterns comprising:
providing an etch target layer where micro-patterns are to be formed;
forming a hard mask layer on the etch target layer;
sequentially forming a first intermediate layer and a second intermediate layer on the hard mask layer;
forming a first photoresist pattern on the second intermediate layer;
forming a second intermediate pattern being a line and space pattern with the widths of embossed portions being greater than the widths of engraved portions by etching a predetermined region of the second intermediate layer;
forming an anti-reflection layer on the entire surface of the second intermediate pattern;
forming a second photoresist pattern which exposes portions of the embossed portions of the second intermediate layer, on the anti-reflection layer;
forming a final second intermediate pattern in the second intermediate pattern by etching the embossed portions of the second intermediate layer using the second photoresist pattern as an etch mask;
forming a first intermediate pattern by etching the first intermediate layer using the final second intermediate pattern as an etch mask;
forming a hard mask pattern by etching the hard mask layer using the first intermediate pattern as an etch mask; and
forming micro-patterns by etching the etch target layer using the hard mask pattern as an etch mask.

22. The method of claim 21 further comprising forming an anti-etching intermediate layer between the first intermediate layer and the second intermediate layer.

23. The method of claim 22, wherein the anti-etching layer is a phenyl triethoxysilanes (PTEOS) layer.

24. The method of claim 21, wherein, in the forming of the second intermediate pattern, the second intermediate layer is partially etched to a predetermined depth.

25. The method of claim 22, wherein, in the forming of the second intermediate pattern, the second intermediate layer is etched completely to expose the anti-etching intermediate layer.

26. The method of claim 21, wherein the anti-reflection layer is formed using a spin-coating method.

27. The method of claim 21, wherein the hard mask layer is a silicon nitride layer, the first intermediate layer is an amorphous carbon layer, and the second intermediate layer is a silicon oxynitride layer.

28. The method of claim 21, wherein the hard mask layer is a silicon nitride layer, the first intermediate layer is an amorphous carbon layer, the anti-etching intermediate layer is an oxide layer, and the second intermediate layer is a silicon oxynitride layer.

29. The method of claim 21, wherein the micro-patterns have a critical dimension of about 60 nm or less.
